(19) United States
(12) Patent Application Publication
(10) Pub. No.: US 2003/0009416 A1
(43) Pub. Date: Jan. 9, 2003

(54) Service for managing channel demand

(76) Inventor: Frank C. Mara, Soquel, CA (US)

Correspondence Address: Cooley Godward LLP, Five Palo Alto Square, 3000 El Camino Real, Palo Alto, CA, 94306, US

(21) Appl. No.: 10/151,732

(22) Filed: May 16, 2002

Related U.S. Application Data
(60) Provisional application No. 60/292,284, filed on May 17, 2001.

(51) Int. Cl. G06F 17/60

(52) U.S. Cl. 705/37

(57) ABSTRACT

A service provides a complete demand management (DM) solution that enables manufacturers to bring together information and processes from both their demand and supply chains in order to streamline production, reduce inventory write-downs, increase revenues, and improve their competitive position in their markets. The service specifically enables sales and marketing managers to gather and measure demand forecasts from both direct and indirect channels; tabulate the accuracy of demand forecasts over time; feed adjusted forecast data to their enterprise resource planning (ERP) and supply chain systems; allocate inventory in real-time to top-tier partners; reward partners who provide consistently accurate forecasts with entitlements such as market development funds (MDFs), discounts, and higher inventory allocation levels; and give both supply and demand chain partners increased visibility into forecasts, capacity, inventory, and stock-on-hand.

### FIELD OF THE INVENTION

The present invention relates generally to demand management, and more particularly to techniques for integrating management of demand and flow of product from the supply chain through partner demand channels of a business.

### BACKGROUND OF THE INVENTION

As e-commerce and other selling over the Internet began to become more commonplace, many manufacturers and vendors believed that it would mean the death of the middleman. Vendor organizations dreamed of a utopian market in which they would save considerable amounts of money by selling goods and services directly to customers, bypassing wholesalers and indirect selling channels. Many predicted that a new era of “disintermediation” would diminish profits to distributors and redirect them back to manufacturers.

To the contrary, with few exceptions, organizations have not proven to be successful at selling exclusively via the Web. Rather than focusing on transactions, organizations are increasingly concerned with how to provide first-rate services and information around these transactions. Successfully selling and servicing customers over the Web routinely involves various kinds of intermediaries—not only the customary wholesalers and retailers, but also content providers, affiliate sites, search engines, portals, Internet service providers (ISPs), and software developers. In fact, some might claim that the Internet has led to hypermediation. In the virtual world, as in the physical world, customers seek a wide selection of goods and services from which to choose and do not want to be restricted to a single product line or confined to limited customer service. As the market evolves, the Internet is not replacing the role of the middleman; it is extending it.

In short, channel managers and vendor organizations face multiple hurdles. These challenges have only increased since the growth of the Internet as a new medium for communication, which has significantly augmented the interaction and volume of activity a customer has with a company. Fundamentally, vendors require solutions and new approaches to optimize channels, capture mindshare, reduce partner churn rates, increase brand equity, and boost the overall competency and productivity of their partners. In contrast, partners want more and better leads, access to relevant product material and market intelligence, tools to quickly launch campaigns, and better education and certification systems.

Meanwhile, with the Web making choices virtually limitless, and with competition only a mouse click away, channel partners—just like consumers—can demand better than second-rate service. Increasingly, partners want personalized, one-to-one communication and service—wherever, whenever, and however they choose.

Partner Relationship Management (PRM) services help vendors exploit new opportunities created by the Internet to optimize indirect sales and distribution channels. With such solutions, rather than disenfranchising manufacturers and vendors, the Internet provides a new medium through which information can be managed and disseminated and products and services delivered.

Ideal PRM services include tools for the following:

Communication and market intelligence: As products become more complex, it is increasingly important that partners have on-demand access to up-to-date product information, competitive data, relevant news and trends, and market intelligence. This access helps channel partners to sell effectively and create preference for a particular brand.

Partner management: Today, alliances account for about 26% of Fortune 500 revenues compared with only 11% five years ago. As the value of strong business and partner relationships heightens, organizations will increasingly demand better tools to manage and optimize these relationships. These tools give them increased capacity to reward based on performance and new insight on how to drive revenue through the channel.

Transaction services: Money is a key link between vendors and their partners. Effective channel programs must leverage all revenue opportunities and enable business to occur easily, quickly, and efficiently. Vendors that can distribute actionable leads in real time to partners and provide business tools to manage these leads through the complete selling process will capture increased mindshare through the channel.

Training and certification: Internet-based, on-demand training and certification for partners and resellers can greatly reduce the time and resources invested in formal, face-to-face education. Additionally, training materials and online courses that can be customized and delivered to targeted audiences and/or different business levels have higher rates of success.

Despite the advantages provided by existing PRM solutions, some challenges remain. FIG. 1 is a top-level block diagram illustrating a typical business environment. As shown in FIG. 1, PRM is provided for managing demand chains between the business and its partners. As further shown in FIG. 1, supply chain management (SCM) is provided for managing supply chains between the business and its suppliers. It should be noted that, as also shown in FIG. 1, a business may have direct connections with buyers in addition to connections through partners.

In the 1990's and early 2000's manufacturers invested significantly in technologies and processes to streamline the supply chain and deliver just-in-time manufacturing capabilities through the use of SCM systems and the like. However, such systems mainly deal with the back end and do not adequately address overall issues such as just-in-time delivery throughout the channel. Although a solution to such issues remains elusive, it has been recognized by the present inventors that companies that are able to bring their supply and demand chains together in this way will enjoy dramatic reductions in inventory costs, higher revenues from targeted selling strategies, and better competitive position—all from the ability to ship the right products, through the right channel, to the end customer more efficiently and reliably than before.

As exemplified by the most recent economic downturn in 2000-01, companies take billions of dollars in inventory write-offs due to the ‘disconnect’ between their demand management and their production plans. Clearly, the key element in bringing the supply and demand chains together is the channel. With more than 50 percent of revenues generated there, it's been the missing link in terms of feeding good forecast and inventory data into manufacturing. Without good information from the channel, demand management will continue to be a ‘garbage in, garbage out’ process.

Illustrating some of the shortcomings of existing demand management technologies, U.S. Pat. Nos. 6,167,380 and 6,188,989 are directed to techniques for demand management within a distributed organization having its own manufacturing and sales facilities. However, among many shortcomings, these patents do not contemplate, much less solve, how to deal with the situation when demand forecasts can be affected by orders and sales through partners.

It would be advantageous if there was a more accurate way to include forecast demand from the front-end so as to control proper levels of inventory, for example.

### SUMMARY OF THE INVENTION

A service provides a complete demand management (DM) solution that enables manufacturers to bring together information and processes from both their demand and supply chains in order to streamline production, reduce inventory write-downs, increase revenues, and improve their competitive position in their markets. The service specifically enables sales and marketing managers to gather and measure demand forecasts from both direct and indirect channels; tabulate the accuracy of demand forecasts over time; feed adjusted forecast data to their enterprise resource planning (ERP) and supply chain systems; allocate inventory in real-time to top-tier partners; reward partners who provide consistently accurate forecasts with entitlements such as market development funds (MDFs), discounts, and higher inventory allocation levels; and give both supply and demand chain partners increased visibility into forecasts, capacity, inventory, and stock-on-hand.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a top-level block diagram illustrating a typical business environment having a supply chain and demand channels;

FIG. 2 is a functional block diagram of an example demand manager that can be employed by a business in accordance with an aspect of the present invention;

FIG. 3 is an example of a web page that can be presented to partners for forecasting demand in accordance with another aspect of the present invention;

FIG. 4 is a functional block diagram of another example demand manager that can be employed by a business in accordance with another aspect of the present invention;

FIG. 5 is a functional block diagram of yet another example demand manager that can be employed by a business and integrated with supply chain management in accordance with still another aspect of the present invention; and

FIG. 6 is a functional block diagram illustrating an example implementation of a demand manager in a PRM system in accordance with yet another aspect of the present invention.

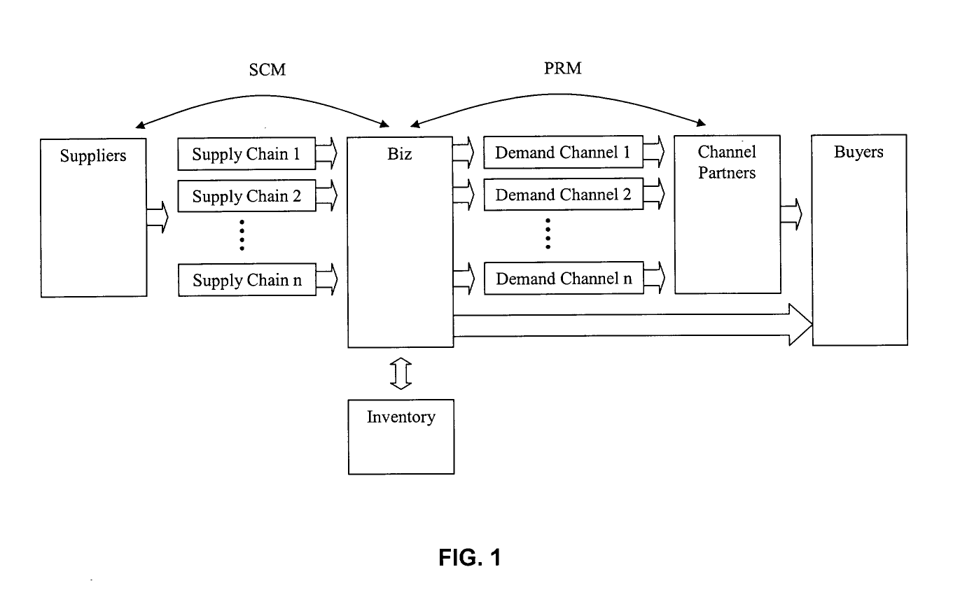

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, where certain implementations are described in terms of software and/or hardware components, those skilled in the art will understand how to implement the invention using various other combinations of software and hardware and the figures and examples below are not meant to limit the scope of the present invention to any single combination of software and hardware. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

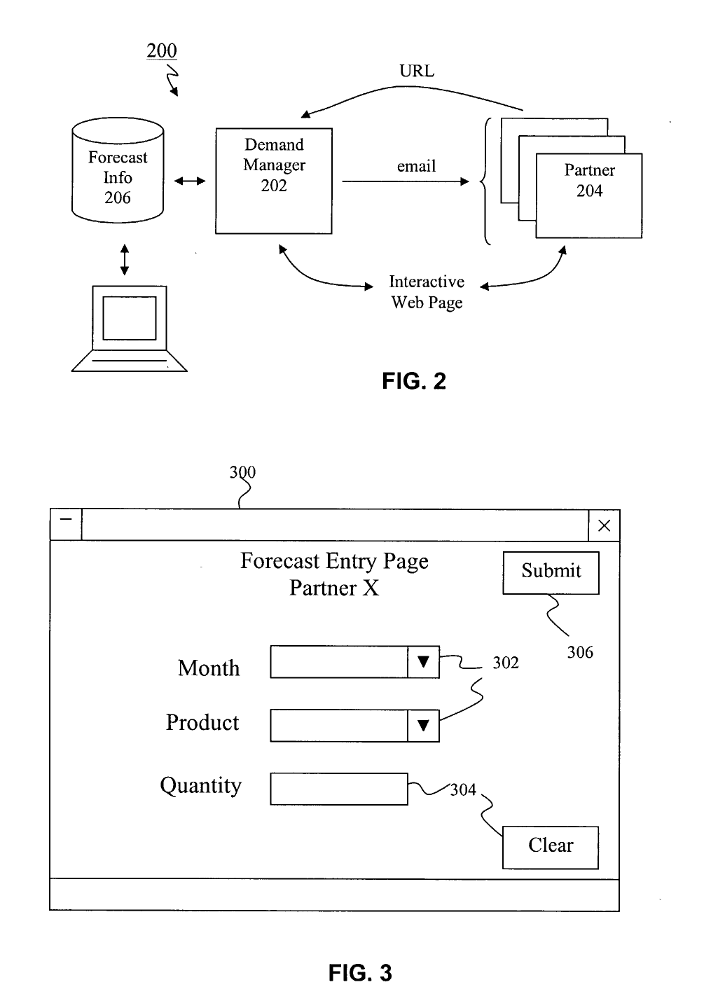

A top-level functional block diagram of an example of the present invention is illustrated in FIG. 2. As shown in FIG. 2, a PRM service 200 includes a demand manager 202 communicates with one or more channel partners 204 and maintains a demand forecast database 206. It should be noted that although the present invention will be described in detail with reference to details concerning demand from buyers through partners, it will be understood that the demand manager may include functionality for handling forecasts of demand directly from buyers other than and/or in addition to demand through partners. It should be further noted that the business may include additional channel partners that are not managed in accordance with the features of the present invention as will be described in more detail below.

In accordance with an aspect of the invention, an email is periodically sent to all partners 204 (via an email server application, for example). It should be noted that either one email is sent per partner, or that certain partners may receive several emails that are separately sent to individual sales persons or managers. It should be further noted that not all partners need be sent the same emails with the same frequency, but that the same or different emails may be sent more or less frequently and at different times for some partners as compared to other partners.

Regardless of the frequency or number of recipients, however, included in the email to each partner is a uniform resource locator (URL) that points to an application hosted by the demand manager (e.g. a CGI script or application), as well as a solicitation for a response from the partner.

Using a computing device such as a PC, and a web browser application such as Internet Explorer, when the channel partner accesses the email and clicks on the URL, it is received by the demand manager (via a web server application such as Apache, for example). In response to the received URL, the referenced application in the demand manager causes an interactive web page (i.e. standard web form) to be sent and displayed (using the web browser, outside of the email program) on the partner's computing device for providing forecast information back to the demand manager.

FIG. 3 is an example web page 300 that can be displayed by a partner's browser in response to the URL pointing to the demand manager's application. As shown in FIG. 3, the web page allows the partner to select forecast parameters via pull down menus 302 and other standard web form interactive components 304. As further shown in FIG. 3, example parameters include a month or other forecast period, a product identifier, and a forecast quantity. When the partner has finished inputting his/her forecast, she simply clicks on the ‘Submit’ button 306 and the forecast information provided in the web page by the partner is sent to the demand manger application. The application extracts the information from the submitted message provided by the partner's web browser and calls a database application for posting the information in the demand forecast database, which database can be indexed by partner (or individual persons therein), forecast period, and/or product, for example.

Periodically, information from the forecast database can be extracted by a channel manager (either automatically by a database application, for example, or manually by request) to an Excel (from Microsoft Corp. of Redmond, Wash.) spreadsheet, for example, and the contents of the database can be reset. Using the information provided by the partners, the present invention thus allows the business to analyze each channel's unconstrained forecast for a given period. This forecast information can be further used to adjust or augment a business's orders to suppliers so as to have the proper amount of inventory for the forecasted period. The present invention therefore provides a novel link between demand chains and supply chains so as to better manage the flow of product therebetween.

Even further advantages can be achieved in accordance with further aspects of the present invention.

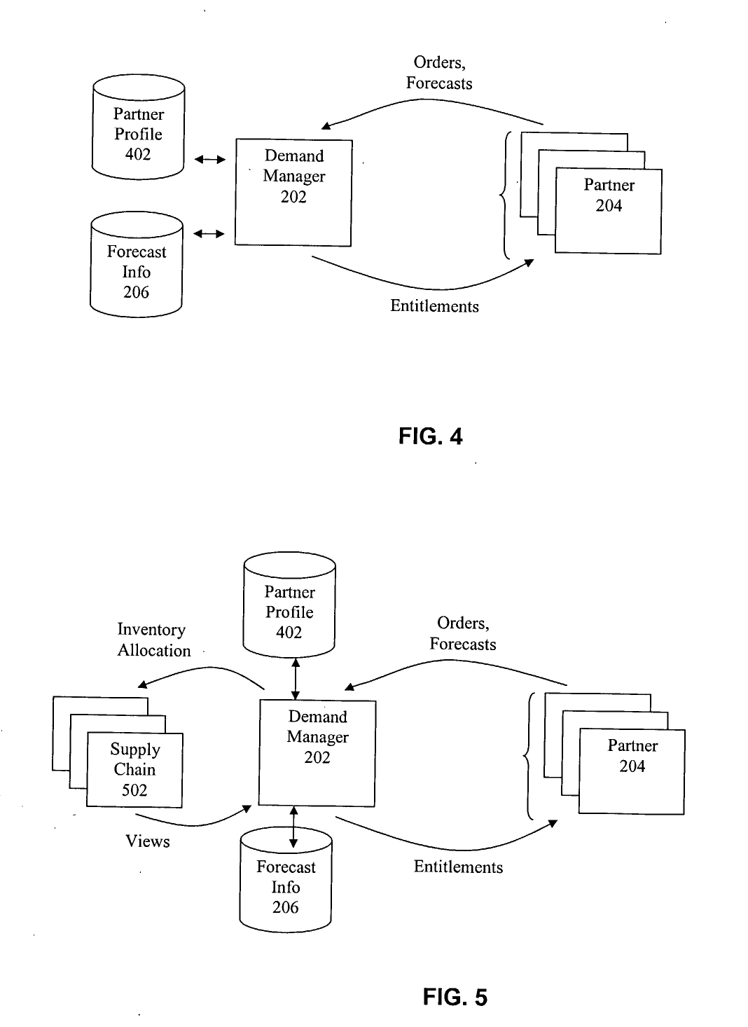

As shown in FIG. 4, the demand manager 202 further maintains a partner profile database 402. Included in each individual partner profile (perhaps in addition to general partner relationship information) is a field in which a value is placed that reflects the rating of the accuracy of the partner's historical forecasts. Accordingly, as actual orders from a partner are received, they are compiled and compared against their forecasts as maintained in forecast database 206. For example, after a certain period has elapsed for which forecasts were collected (e.g. a month), the total number of actual orders and/or sales by a partner are compared with the forecasted amount. The accuracy for each partner for the period may be further compared against all other partners to provide a ranking or rating of partners, for example. It should be noted that where forecasts are provided by more than one individual within a partner organization, such individual forecasts may be compiled together to reflect an organization's collective forecasting accuracy in addition to, or in place of, the individual forecasts. Moreover, the rating and/or ranking values for each partner based on the computed forecast accuracies may be manually input into the database, or they may be input by an automated rating application.

In accordance with the above-described aspects, therefore, the present invention allows a business to track and determine the accuracy of individual partners' forecasts and to single out both good and bad forecasters. Such historical accuracy information can be further used to adjust current forecasts so as to even better manage the flow of product between the supply chain and the demand channels.

Still further advantages can be achieved in accordance with still further aspects of the invention as further illustrated in FIG. 4. For example, the forecast ratings generated as described above can be integrated into a business's partner relationship management program so as to encourage or reward accurate forecasts.

For example, the business may establish rules and/or filters for providing entitlements to partners based upon the individual partner and/or partner organization's rating. Entitlement choices can include discounts, market development funds (MDF's), access rights to information, distribution leads, etc. Such rules and/or filters may be integrated into an existing partner relationship management program so as to provide the entitlement choices as part of such a program.

In accordance with this aspect of the invention, a business can encourage its partners to provide more accurate forecasts, thus improving the flow of product between the supply chain and demand channels, while further strengthening and improving its partnership relationships.

FIG. 5 illustrates still further advantages that can be achieved through further integration with a business's inventory control and/or management of one or more of its supply chains 502. For example, utilizing an integrated platform and rules engine, a business can provide a real time view of its inventory to the channel partners. Likewise, such a platform and rules engine can further implement a real time view of partner's inventory in the channel to the business Moreover, utilizing the integrated platform and rules engine, and building upon the forecast and forecast rating information, a business can provide a recommended inventory allocation plan which optimizes total revenues from the channel partners, either by adapting an existing SCM service or by providing or integrating new SCM tools.

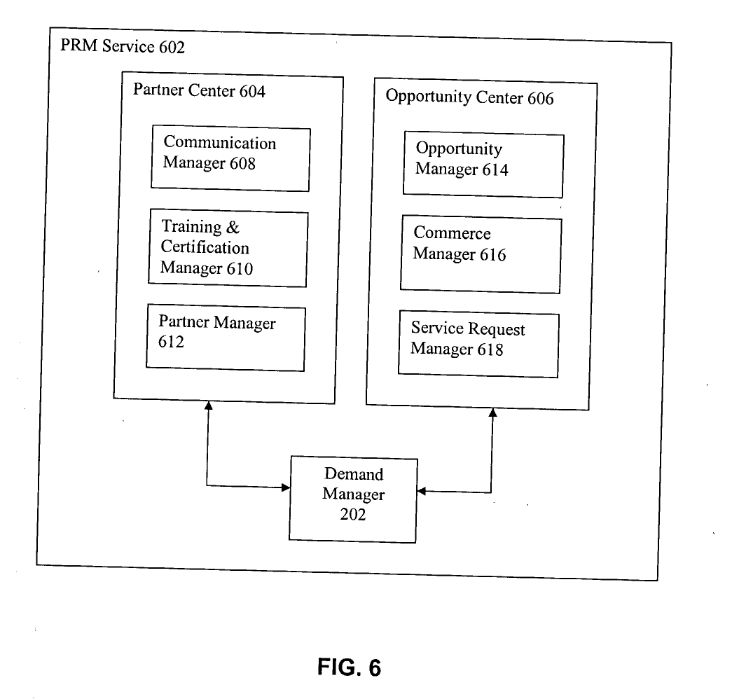

FIG. 6 illustrates one example implementation of the invention, in which the demand management functionality described above is included in an Internet-based PRM service such as Partner Accelerator from OnDemand, Inc. of Menlo Park, Calif. As shown in FIG. 6, PRM service 602 includes two modules: Partner Center 604 and Opportunity Center 606, which may be implemented by software modules and hosted by a server computer, for example.

As further shown in FIG. 6, partner center 604 comprises three integrated modules to help vendors increase channel sales, reduce partner management costs, and build long-term, profitable partner relationships. Communication Manager 608 provides customers with tools for publishing, creating customizable collateral, on-demand campaign and promotion management, and Web conferencing. It also includes community creation and management to facilitate business collaboration and partnering to meet end-customer buying needs. Training and Certification Manager 610 provides both vendor-specific and soft-skills training programs and certification, as well as tools for analysis and reporting. Partners gain access to training and action plans, which can be customized to specific market and geographic needs. And, Web-based training is both time- and cost-effective. Partner Manager 612 simplifies and automates the process to recruit and manage partners. Tracking and reporting capabilities enable vendors to optimize channel activities, and planning tools enable vendors and partners to align their objectives to go to market together.

Still further, as shown in FIG. 6, opportunity center 606 comprises the following core components to help partners and vendors locate, track, and close more sales opportunities. Opportunity Manager 614 helps vendors identify and target successful lead and demand generation programs. It also automates and eases the process to provide program funds to partners and link complementary selling partners together to close more sales. Commerce Manager 616 is an application through which partners can browse a multimedia product catalog, access current price lists and discounts, configure products, create online quotes, and track orders. That makes it easier for partners to sell online and to meet customers' purchasing needs. Service Request Manager 618 is an application which allows partners to access a repository of solutions for vendor products. It includes tools to manage service requests through the service cycle and to ensure that end-customers obtain the services they require quickly and competently.

FIG. 6 illustrates that demand manager 202 as described hereinabove can be integrated within PRM service 602 so as to intercommunicate with partner center 604 and opportunity center 606. However, it should be understood that the functionalities of demand manager 202 can be fully or partially integrated with the functionalities of the various manager modules in the partner center 604 and opportunity center 606.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications.

What is claimed is:

1. A PRM service comprising:
a demand manager that distributes an interactive entry page to channel partners for retrieval of demand forecasts from the channel partners.

2. A PRM service according to claim 1, wherein the demand manager distributes the interactive entry page by email.

3. A PRM service according to claim 2, wherein the email includes a URL pointing to an application in the demand manager that provides for the interactive entry and retrieval of demand forecasts via the interactive entry page.

4. A PRM service according to claim 1, wherein the demand forecasts are used to adjust a level of inventory.

5. A PRM service, comprising:
a demand manager that collects demand forecasts from channel partners and computes a rating for the channel partners based on an accuracy of the demand forecasts.

6. A PRM service according to claim 5, wherein the accuracy is computed based on a comparison of the demand forecasts and actual orders from the channel partners.

7. A PRM service according to claim 5, wherein the rating for at least one of the channel partners includes an aggregate of ratings for individual persons associated with the at least one channel partner.

8. A PRM service according to claim 5, wherein the demand forecasts are used to adjust a level of inventory.

9. A PRM service, comprising:
a demand manager that receives demand forecasts from certain of its channel partners, determines an accuracy of the demand forecasts for each of the certain channel partners, and provides entitlements to the certain channel partners based on the accuracy.

10. A PRM service according to claim 9, wherein the demand manager further ranks the certain channel partners based on the accuracy.

11. A PRM service according to claim 9, wherein the entitlements include one or more of a discount, an MDF, a right to access information, and a lead for distribution.

12. A PRM service according to claim 9, wherein the accuracy for the certain partners is maintained in a partner profile database.

13. A PRM service according to claim 9, wherein the demand forecasts are used to adjust a level of inventory.
